(19) United States
(12) Patent Application Publication
(10) Pub. No.: US 2003/0204574 A1
(43) Pub. Date: Oct. 30, 2003

(54) System and method for configuring network access devices

(76) Inventor: Oleg Kupershmidt, Swampscott, MA (US)

Correspondence Address: BANNER & WITCOFF, 1001 G STREET N W, SUITE 1100, WASHINGTON, DC, 20001, US

(21) Appl. No.: 09/822,699

(22) Filed: Mar. 30, 2001

(51) Int. Cl. H04L 9/32; G06F 11/30; G06F 12/14; G06F 15/177

(52) U.S. Cl. 709/220; 370/254; 370/401

(57) ABSTRACT

A system and method are disclosed for configuring network access equipment by utilizing a data storage card or a smart card in response to a request for service from a subscriber to a network application service provider. The system includes a card writer for writing configuration data from an application service provider to the card, and a card reader for downloading the configuration settings into the network access equipment from the card. The card may also include provisions for authentication and non-repudiation of service configurations received via a public key cryptography system.

### FIELD OF THE INVENTION

This invention relates to network communication systems and, in particular, to a system and method for configuring network access equipment.

### BACKGROUND OF THE INVENTION

In the present state of the art, the procedures for configuring network access devices, such as subscriber modems and integrated access devices, have not yet been standardized within the relevant network communications field. Consequently, the conventional procedure for configuring subscriber equipment is likely to differ from one modem and device manufacturer to another. If the subscriber is technically capable, he may attempt to configure the modem and associated integrated access device himself by following step-by-step instructions included in a ‘start kit’ provided by the equipment manufacturer.

However, the subscriber may not be successful or, if successful, he may have accomplished nothing more than setting ‘default’ values in his equipment. In reality, as network access equipment has evolved from bridges and simple routers, and has become technically more sophisticated, configuration of such modems and other devices requires the expertise of a qualified technician who performs this task at the customer premises equipment (CPE). It can be appreciated that, as the number of network service subscribers continues to grow at an ever-increasing rate, it becomes burdensome and economically unfeasible for network service providers to train and send out technicians to configure the equipment of each new subscriber signing on for service.

What is needed is a method for configuring network access equipment which does not require the presence of a service provider technician.

It is therefore an object of the present invention to provide a method by which an unassisted subscriber can configure network access equipment.

It is a further object of the present invention to provide a method for configuring network access equipment produced by different manufacturers.

Other objects of the invention will be obvious, in part, and, in part, will become apparent when reading the detailed description to follow.

### SUMMARY OF THE INVENTION

The present invention results from the observation that a data storage card, preferably an active or ‘smart’ card, may be used to provide requested configurations, device drivers, and software images to a new or an existing network service subscriber using a network access device. The system includes a data card writer for writing configuration data from an application service provider to the data card, and a data card reader for downloading the configuration settings into the network access equipment from the data card. Use of a smart card would also enable diagnostic utilities and troubleshooting for verifying network access device parameters such as compatibility and line quality, as well as including authentication and non-repudiation of provided service configuration via a private key. The disclosed method provides for seamless network access and can aid in service maintenance, as the application service provider can distribute new replacement data cards as needed having upgraded capabilities.

### BRIEF DESCRIPTION OF THE DRAWINGS

The invention description below refers to the accompanying drawings, of which:

FIG. 1 is a diagrammatical representation of a communications network in accordance with the present invention; and

FIGS. 2A and 2B are a flow diagram describing the configuration method used in accordance with the network of FIG. 1.

### DETAILED DESCRIPTION OF AN ILLUSTRATIVE EMBODIMENT

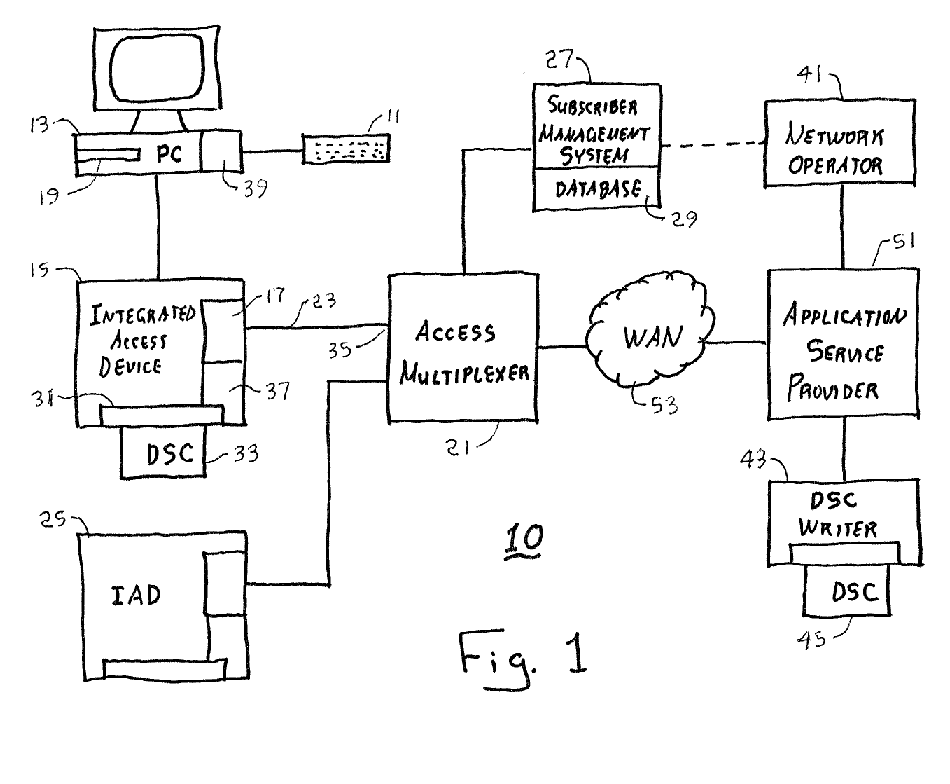

There is shown in FIG. 1 a communication network 10 in accordance with the present invention. The communication network 10 includes an application service provider 51, such as a Digital Subscriber Line (DSL) server, providing a desired network service. In a typical application, the network service is requested by a subscriber 11 operating a computer 13. The requested service is accessed via a network access device such as a modem or an integrated access device (IAD) 15, where the network access device communicates with the computer 13. The integrated access device 15 comprises a ‘smart’ CPE and is thus able to provide integration of various access technologies and services to the subscriber 11. Whereas a conventional CPE may deliver only data services, the integrated access device 15 provides additional service. In one preferred embodiment, for example, the integrated access device 15 provides voice transmission, streaming media, and data services.

The integrated access device 15 includes a router 17, such as a DSL router, by which the subscriber 11 may be connected to the application service provider 51 through a network, such as a Wide-Area Network (WAN) 53, for example. For a DSL communication network, the requested service may be provided via a loop 23 and an access multiplexer 21, such as a Digital Subscriber Line Access Multiplexer (DSLAM). The access multiplexer 21 is used to aggregate traffic from individual subscribers into a higher-capacity stream for transmission through the WAN 53 or other network. The access multiplexer 21 may also be connected to one or more additional integrated access devices, here represented by a remote integrated access device 25. The access multiplexer 21 is in communication with (i.e., controlled by) a subscriber management system 27 which has access to information relevant to various network subscribers, including the subscriber 11.

In accordance with a preferred embodiment of the present invention, the integrated access device 15 further includes a data storage card reader 31 which is used to read an inserted subscriber data storage card 33 provided by a network operator 41, as described in greater detail below. The subscriber data storage card 33 is used to store configuration information and settings necessary to initiate proper operation of the integrated access device 15.

In an alternative preferred embodiment, the subscriber data storage card 33 may be used with a PC data storage card reader 19 incorporated into the computer 13 used by the subscriber 11. The process for configuring the integrated access device 15 is essentially the same whether the PC data storage card reader 19 or the data storage card reader 31 is used to read the subscriber data storage card 33.

When the subscriber 11 initially signs up for the desired service, the subscriber data storage card 33 is prepared by downloading, or storing, therein configuration settings compatible with the integrated access device 15 and with the access multiplexer 21. Preferably, the configuration settings include voice and data configuration settings. The subscriber data storage card 33 can be prepared by the network operator 41, or alternatively, by the application service provider 51. The subscriber data storage card 33 includes information to configure the router 17. A corresponding access multiplexer port 35 is typically configured by the network operator 41. After the data storage card 33 has been prepared, it is provided to the subscriber 11 for use in configuring the integrated access device 15.

The settings and configurations utilized in the integrated access device 15, and in the integrated access device 25, are determined by the application service provider 51. The application service provider 51 controls a data storage card writer 43, which serves to configure the data storage card 33 and other data storage cards, such as may be used for configuring the remote integrated access device 25, for example.

The subscriber data storage card 33 is preferably an active data storage card including a memory and an operating system (e.g., an integrated circuit containing a microprocessor and input/output circuitry), such as found in the storage device commonly known in the relevant art as a ‘smart card.’ Use of an active, or smart, card allows the network operator 41 or the application service provider 51 to load configuration settings and information for a plurality of network access devices and access multiplexers into one data storage card suitable for installation into any one of several different network access devices. The active data storage card can then be used by subscribers having hardware devices provided by various manufacturers. When installed in the respective data storage card reader 31, the operating system in the active data storage card will function to identify the particular device manufacturer and model, for example, and install the appropriate drivers and settings.

Use of an active, or smart, data storage card would also provide for diagnostic utilities and troubleshooting to verify network access device parameters such as compatibility and line quality. An active data storage card would also include provisions for the authentication and non-repudiation of services via a private key cryptography system. The active, or smart, data storage card also aids in service maintenance, whereby the network operator or application service provider can distribute new replacement data cards having upgraded capabilities on an as-needed basis.

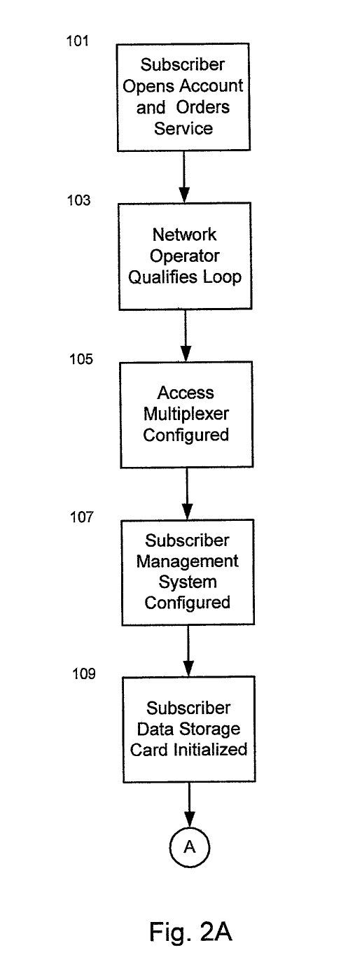

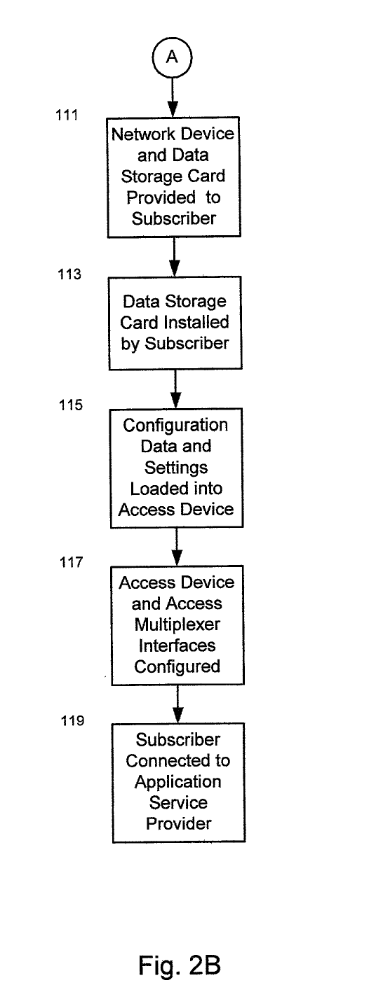

The method of configuring the integrated access device 15 is best explained with reference to the flow diagram of FIG. 2. To obtain access to network-provided resources, the subscriber 11 requests an account and a service, such as broadband Internet Protocol (IP) DSL service, for example, from the network operator 41, in step 101. The network operator 41 qualifies the loop 23, in step 103 and if necessary, loop unbundling is performed for DSL service. The network operator 41 configures the access multiplexer 21, in step 105.

If the subscriber 11 uses the data storage card reader 31 in the integrated access device 15 for reading the subscriber data storage card 33, the integrated access device 15 can be configured to incorporate a restart, or ‘boot,’ function which automatically takes into account configuration settings and other instructions from the installed data storage card 33. Preferably, the integrated access device 15 includes a software component 37 for controlling this process. If, in the alternative embodiment, the subscriber uses the PC data storage card reader 19 in the computer 13, configuration can be accomplished by having the computer 13 respond to an appropriate command issued by a management application in the integrated access device 15. The configuration process is preferably controlled by a PC software program 39, as can be appreciated by one skilled in the relevant art.

The network operator 41 next configures the subscriber management system 27, in step 107, by setting the name of the subscriber 11. Additionally, a password, a public key, and an IP address are set, or assigned, for the subscriber 11. An ATM Permanent Virtual Circuit (PVC) for a Virtual Path Identifier/Virtual Channel Identifier (VPI/VCI) pair, and traffic shaping (e.g. Unspecified Bit Rate UBR) are set. Additionally, the authentication is set.

The integrated access device 15, located at the subscriber's premises, is the termination port for the service provider network (e.g., WAN 53). As best appreciated by one skilled in the relevant art, the integrated access device needs to be configured whenever the physical, transport, and application layers are utilized for carrying the requested application service.

For example, DSL can be used for providing transport layer connectivity between the integrated access device 15 and the access multiplexer 21 over the loop 23 (i.e., the physical layer). In some configurations, there is minimal configuration required and the integrated access device 15 can self-train for the best achievable upstream/downstream transmission rates. However the network operator 41 is able to restrict the bandwidth utilized by suitably configuring the access multiplexer port 35 and/or the router 17.

DSL parameters may include minimum/maximum transmission rates, various threshold parameters, noise margins, and interleaf depth, for example. DSL often carries ATM traffic that requires configuration of PVC and quality of service (QoS) parameters. For example, voice traffic usually utilizes a constant bit rate (CBR) protocol with ATM cells handled through high-priority queues. In contrast, data traffic usually can be carried using a variable bit rate (VBR) protocol. Depending on the manufacturer, network access devices may have various sets of QoS parameters (e.g. CLP, MBS, SCR, CLR, CTD, CDV). Traffic shaping, utilized to smooth the ATM cell stream, eliminate peaks and cell jitters, and reduce burst lengths may also be configurable.

ATM is often used to achieve IP level connectivity so that applications can be used, with frame relay protocol available as an alternative. Preferably, either dynamic IP addressing (e.g. using DHCP) or static IP addressing needs is assigned to the integrated access device 15. Alternatively, the integrated access device 15 can be configured to use a Network Address Translation (NAT) protocol. Also, user authentication protocol can be set (e.g. using peer-to-peer protocol over ATM), dynamic routing can be enabled, and static routing tables can be configured. If either the integrated access device 15 or the access multiplexer 21 includes a built-in firewall, the subscriber 11 can outsource management tasks to the application service provider 51, for regularly receiving data storage cards 33 which include updated configuration data.

The network operator 41 initializes the subscriber data storage card 33 by writing therein an identification (ID) and secret key for the subscriber 11, in step 109. This operation is performed with the subscriber data storage card 33 inserted into the data storage card writer 43 which is in communication with the network operator 41 (or the application service provider 51). The network operator 41 generates a unique cryptographic key for each new subscriber. The subscriber's secret key is stored in the subscriber data storage card 33, and the public key is stored in a database 29 in the subscriber management system 27. The network operator 41 subsequently specifies or provides to the subscriber the integrated access device 15, the data storage card reader 31, and the initialized subscriber data storage card 33, in step 111.

The network operator 41 also includes the ATM PVC, with one or more VPI/VCI pairs, and an ATM service class for each ATM PVC in the initialized subscriber data storage card 33. In the initialized subscriber data storage card 33, the ATU-C (download) Data Rate Min is specified to be the same as in the access multiplexer 21. Additionally, the ATU-C Data Rate Min, the ATU-R (upload) Data Rate Max, and the ATU-R Data Rate Min are all specified to be the same as in the access multiplexer 21. Other parameters, such as use of network address translation, may be included in the procedure of initializing the subscriber data storage card 33.

Upon re-start, the integrated access device 15 is directed to load necessary settings and to auto-configure itself. The subscriber 11 receives the initialized subscriber data storage card 33 and activates the integrated access device 15 after inserting the subscriber data storage card 33 into the data storage card reader 31 or into the PC data storage card reader 19, in step 113. Upon booting the computer 13, the subscriber data storage card 33 supplies the ATM PVC settings and the other parameters needed to establish connection between the integrated access device 15 and the subscriber management system 27, in step 115. At this stage, the integrated access device 15 has been correctly configured without requiring direct input from the subscriber 11, at step 117, and the subscriber 11 obtains connection to the application service provider 51, at step 119.

Among the advantages provided by the above-described procedure is the assurance to the subscriber 11 that the configuration settings provided for the integrated access device 15 and for the access multiplexer port 35 will be correct settings. Additionally, further settings can be provided to the integrated access device 15 after the installation of a private encryption/decryption key to provide secure transactions, as described in greater detail below.

In a preferred embodiment, the integrated access device 15 maintains profiles for the subscriber 11. Each subscriber profile contains configuration settings and relevant public key information loaded from the database 29 of the subscriber management system 27. At a time subsequent to initialization of the integrated access device 15, updated configuration settings can be loaded whenever a new data storage card 45, shown as being prepared by the application service provider 51, in FIG. 1, is used successfully for the first time in the integrated access device 15. When the network operator 41 provides the new data storage card 45, which may have, for example, upgraded configurations, drivers, software images, or diagnostics applications, the integrated access device 15 validates the new data storage card 45 by using the public key stored in the profile for the subscriber 11. This validation can be performed without connection to the subscriber management system 27.

Additionally, the private key feature can be used for authentication and non-repudiation of service configuration. By authentication is meant that configuration settings are those as authorized by the network operator 41, and which have not been modified or tampered with. By non-repudiation is meant that delivery of service settings to the subscriber 11 is documented, and that the subscriber 11 would not be able to deny receipt of delivered service settings. If the process were unsecured, application services could be misappropriated or acquired without payment for the services, for example.

Thus, in a preferred embodiment, the integrated access device 15 authenticates a new data storage card by using the public key available from the network operator 41. This is done to insure that the settings applied to the integrated access device 15 are genuine, or valid. Otherwise, subscriber configuration information, such as routing tables and firewall settings, can be compromised without proper control. Preferably, the authentication is achieved via a digital signature. The digital signature is generated by encrypting the authorized configuration settings with a secret key provided in the subscriber data storage card 33. The digital signature is subsequently verified by the integrated access device 15 using a corresponding public key, as is known in the relevant art.

Non-repudiation of service configuration is performed at the time an application service is changed so as to ensure that the changes are made in accordance with an authorized process. This is achieved by effecting the configuration changes via the subscriber data storage card 33 provided by the network operator 41 instead of by allowing the subscriber to implement configuration changes himself. Moreover, because service configuration requires use of the subscriber data storage card 33, the network operator 41 is assured that a newly-provided or a modified application service is configured in accordance with the customer order.

In an alternative preferred embodiment, one or more diagnostic routines stored in the subscriber data storage card 33 can be used to evaluate the performance of the subscriber computer 13, or of the integrated access device 15, and to send the results to the network operator 41. Such diagnostic routines preferably address issues related to network usage.

In yet another preferred embodiment, if the subscriber 11 experiences network delays or a reduction in QoS, the network operator 41 can respond by running a series of diagnostic tests from an application resident in the subscriber data storage card 33. Test results are digitally signed and forwarded by the integrated access device 15 to the subscriber management system 27 for further analysis. As can be appreciated by one skilled in the relevant art, this feature provides for a diagnosis of the integrated access device 15 without requiring intervention by the subscriber 11 or by a service technician.

While the invention has been described with reference to particular embodiments, it will be understood that the present invention is by no means limited to the particular constructions and methods herein disclosed and/or shown in the drawings, but also comprises any modifications or equivalents within the scope of the claims.

What is claimed is:

1. A method for configuring a network access device, said method comprising the steps of:
storing, in a data storage card, configuration settings compatible with the network access device;
loading said configuration settings into the network access device from said data storage card; and
configuring the network access device using said configuration settings
such that network communication is established between the network access device and a network application service provider.

2. The method of claim 1 further comprising the step of configuring an access multiplexer in communication with the network access device.

3. The method of claim 2 wherein said access multiplexer comprises a digital subscriber line access multiplexer.

4. The method of claim 2 further comprising the step of configuring a subscriber management system in communication with said access multiplexer.

5. The method of claim 1 wherein said step of storing said configuration settings comprises the step of inserting said data storage card into a data storage card writer.

6. The method of claim 1 wherein said step of loading said configuration settings comprises the step of inserting said data storage card into a data storage card reader in the network access device.

7. The method of claim 1 wherein said step of loading said configuration settings comprises the step of inserting said data storage card into a data storage card reader in a computer connected to the network access device.

8. The method of claim 1 wherein said data storage card comprises a memory and an operating system.

9. The method of claim 8 further comprising the step of installing a private encryption/decryption key in the network access device.

10. The method of claim 1 wherein said step of storing configuration settings is performed by a member of the group consisting of a network operator and an application service provider.

11. The method of claim 1 further comprising the step of providing said data storage card to a subscriber of the network application service provider.

12. The method of claim 1 wherein said configuration settings comprises voice and data configuration settings.

13. The method of claim 1 further comprising the step of setting a network protocol address for the network access device.

14. The method of claim 1 further comprising the step of setting a permanent virtual circuit for a virtual path identifier/virtual channel identifier pair.

15. A system for configuring a network access device suitable for providing a subscriber access to a network application service, said system comprising:
a data storage card writer in communication with a network application service provider, such that said network application service provider can store configuration settings for the subscriber into a data storage card via said data storage card writer; and
a data storage card reader in communication with the network access device, such that said data storage card reader can download said configuration settings into the network access device from said data storage card via said data storage card reader.

16. The system of claim 15 wherein said data storage card comprises a memory and an operating system.

17. The system of claim 15 further comprising software that downloads said configuration settings from said data storage card into the network access device.

18. The system of claim 17 wherein said software resides in the network access device.

19. The system of claim 17 wherein said software resides in a computer in communication with the network access device.

20. The system of claim 17 wherein said software comprises a diagnostic routine.

21. The system of claim 16 further comprising software that installs a private encryption/decryption key in the network access device.

22. The system of claim 15 wherein said configuration settings comprise voice and data configuration settings.

23. The system of claim 15 further comprising an access multiplexer for connecting the network access device to an application service provider network.

24. The system of claim 23 further comprising a subscriber management system in communication with said access multiplexer, said subscriber management system for maintaining subscriber profiles.

25. The system of claim 23 wherein said configuration settings comprise configuration information compatible with said access multiplexer.

26. The system of claim 23 wherein said access multiplexer comprises a digital subscriber line access multiplexer.

27. A system for providing a subscriber access to a network application service, said system comprising:
a network access device;
a data storage card having network application configuration settings loaded therein;
a data storage card reader in communication with said network access device, said data storage card reader for loading said configuration settings from said active data storage card into said network access device.

28. The system of claim 27 wherein said data storage card comprises a memory and an operating system.

29. The system of claim 27 further comprising software that controls the loading of said configuration settings into said network access device.

30. The system of claim 29 wherein said software resides in a computer in communication with said network access device.

31. The system of claim 29 wherein said software comprises a diagnostic routine.

32. The system of claim 28 further comprising software that controls the installation of a private encryption/decryption key in said network access device.

33. The system of claim 27 further comprising an access multiplexer for connecting said network access device to an application service provider network.

34. The system of claim 33 wherein said access multiplexer comprises a digital subscriber line access multiplexer.

35. The system of claim 27 wherein said configuration settings comprise voice and data configuration settings.

36. The system of claim 27 further comprising a data storage card writer in communication with the network application service, said data storage card writer for storing said configuration settings in said data storage card.

37. A system for configuring a network access device suitable for providing a subscriber access to a network application service, said system comprising:
a data storage card writer in communication with a network application service provider, such that said network application service provider can load configuration settings, diagnostic routines, and encryption data for the subscriber into a smart card via said data storage card writer;
a data storage card reader in communication with the network access device, such that said data storage card reader can download said configuration settings into the network access device from said smart card via said data storage card reader; and
a digital subscriber line access multiplexer in communication with said network application service provider and with said network access device, for providing the subscriber access to the network application service via the network access device.

38. The system of claim 37 further comprising a subscriber management system in communication with said digital subscriber line access multiplexer, said subscriber management system including a database for maintaining subscriber profiles.

39. The system of claim 37 wherein said configuration settings comprise voice and data configuration settings.

40. The system of claim 37 wherein said encryption data comprises a subscriber secret key.
